(19) United States
(12) Patent Application Publication
(10) Pub. No.: US 2003/0202267 A1
(43) Pub. Date: Oct. 30, 2003

(54) Electro-optical device, method for manufacturing the same, and electronic apparatus

(75) Inventors: Yasuji Yamasaki, Chino-city (JP); Tomohiko Hayashi, Chino-city (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 10/387,515

(22) Filed: Mar. 14, 2003

(30) Foreign Application Priority Data
Mar. 22, 2002 (JP) 2002-081069

(51) Int. Cl. G02B 5/08; G02B 7/182

(52) U.S. Cl. 359/883

(57) ABSTRACT

An electro-optical device includes a substrate; pixel electrodes disposed above the substrate; switching elements; an interlayer insulating film disposed at a position higher than the switching elements and lower than the pixel electrodes; contact holes, disposed in the insulating film, to connect the switching elements to the corresponding pixel electrodes; and filler, disposed in the corresponding contact holes, including a conductive material. Therefore, light leakage caused by vacant contact holes disposed in a layered structure on a substrate is reduced or prevented, thereby displaying a high-quality image.

### BACKGROUND OF THE INVENTION

1. Field of Invention

The present invention relates to electro-optical devices, methods for manufacturing such devices, and electronic apparatuses. The present invention particularly relates to an electro-optical device in which switching elements and pixel electrodes on a substrate are connected to each other with contact holes, a method for manufacturing such an electro-optical device, and an electronic apparatus including the electro-optical device.

2. Description of Related Art

The related art includes an electro-optical device in which so-called active matrix addressing is possible. Such an electro-optical device includes pixel electrodes arranged in a matrix, thin-film transistors (hereinafter “TFTs”) connected to the corresponding pixel electrodes, scanning lines, and data lines. The scanning lines and data lines are connected to the corresponding TFTs, the scanning lines are arranged in parallel to the row direction of the matrix, and the data lines are arranged in parallel to the column direction of the matrix.

When this electro-optical device further includes a TFT array substrate having storage capacitors connected to the TFTs, a counter substrate that faces the TFT array substrate and has a common electrode, and an electro-optical material, such as a liquid crystal, disposed between the TFT array substrate and the counter substrate in addition to the above TFTs, scanning lines, and data lines, an image can be displayed by changing the state of the electro-optical material in each pixel with a predetermined potential applied between each pixel electrode and the common electrode. When the electro-optical material is, for example, liquid crystal, a change in the state of the electro-optical material in each pixel results in a change in the transmissivity of each pixel. Thereby, an image can be displayed.

Components, including the TFTs, scanning lines, and data lines, disposed on the TFT array substrate form a layered structure in general. For example, the TFTs, an interlayer insulating film, the storage capacitors (each including a lower electrode, a dielectric film, and an upper electrode), another interlayer insulating film, and the data lines are disposed on the TFT array substrate in that order. The above pixel electrodes are usually disposed on part of the top of the layered structure. When the electro-optical material is liquid crystal, an alignment layer to maintain the orientation of the liquid crystal in a predetermined state is disposed on the pixel electrodes in some cases.

In such a configuration, as described above, each interlayer insulating film, such as a silicon oxide film or a silicon nitride film, is disposed between components so as to prevent a short circuit from arising between the components, or to reduce such short circuits. Furthermore, since drain electrodes of the TFTs must be electrically connected to the pixel electrodes and other components must be also connected to each other, contact holes for connection are disposed at a predetermined region of each interlayer insulating film. These contact holes are formed by dry-etching the interlayer insulating film.

### SUMMARY OF THE INVENTION

However, the electro-optical device with such a structure is subject to the following problem. That is, the above-mentioned contact holes disposed in the interlayer insulating film deteriorate the flatness of the layered structure. For example, there is a risk that recessed portions remain at positions corresponding to the contact holes under, for example, the above-mentioned alignment layer, which is the top of the layered structure. Such recessed portions arise from the fact that the contact holes have a cavity therein.

When the recessed portions are disposed under the alignment layer, there is a risk that the orientation of the liquid crystal will be disordered due to such a configuration, thereby deteriorating the image quality. For example, when an entirely black image is displayed, the displayed image has low contrast due to light leakage caused by the disorder.

Such light leakage is caused by not only the recessed portions but also the contact holes themselves. The reason is as follows: the contact holes have a cavity therein, and therefore light can be readily transmitted in the cavity.

The present invention addresses or solves the above and/or other problems, and provides an electro-optical device and an electronic apparatus that do not suffer from leakage caused by contact holes disposed in layers on a substrate, or reduces such leakage, and can therefore display a high-quality image.

In order to address or solve the above, an electro-optical device according to the present invention includes a substrate; pixel electrodes disposed above the substrate; switching elements arranged so as to correspond to the pixel electrodes; an interlayer insulating film disposed at a position higher than the switching elements and lower than the pixel electrodes; contact holes, disposed in the insulating film, to connect the switching elements to the corresponding pixel electrodes; and filler, disposed in the corresponding contact holes, including a conductive material.

In an electro-optical device of the present invention, each thin-film transistor functioning as a switching element is connected to a corresponding data line, to which image signals are transmitted, functioning as a wiring line. Thereby, the image signals are transmitted to each pixel electrode through the data line, the thin-film transistor, and a corresponding contact hole in that order. When the electro-optical device has a configuration in which an electro-optical material, such as liquid crystal, is placed between each pixel electrode and a common electrode, the state of the electro-optical material can be changed by applying a potential between the pixel electrode and the common electrode. The light transmissivity can thus be changed when the electro-optical material is a liquid crystal, thereby displaying an image.

In the present invention, each switching element is electrically connected to the corresponding pixel electrode with the corresponding contact hole disposed in the interlayer insulating film placed between the switching element and the pixel electrode. The contact hole is filled with filler comprising a conductive material.

According to such a configuration, the switching element can be electrically connected to the corresponding pixel electrode easily in an effective manner, and the electrical connection is more securely maintained by the filler, as compared with related art techniques. The reason is as follows: the filler including a conductive material is disposed at the contact portion between the contact hole and the switching element and the contact portion between the contact hole and the pixel electrode, thereby lowering the resistance.

Furthermore, in the present invention, the following effects provided by the filler can be obtained. Since the contact hole is filled with the filler so as not to allow cavities to remain, or to reduce such cavities, a layer disposed on the contact holes does not have recessed portions thereunder. Therefore, for example, when an alignment layer is disposed on the pixel electrodes, the alignment layer does not have such recessed portions thereunder. Thus, the orientation of liquid crystals in contact with the alignment layer is not disordered, thereby reducing or preventing the occurrence of problems as much as possible, such as the degradation of image quality which is caused by, for example, low contrast. In related art configurations, light is transmitted in the cavities. However, in the present invention, the transmission is reduced or prevented in principle because the cavities are filled with the filler, thereby reducing or preventing degradation of the image quality.

As described above, according to the present invention, an image having higher quality can be displayed.

A particular example of the filler preferably includes a light-shielding material and a transparent conductive material, as described in below-mentioned exemplary embodiments of the present invention. However, in the present invention, the filler is not limited to such materials. That is, in principle, the contact holes may be filled with any material. Thus, the filler including a conductive material, as specified in the present invention, may include any kind of metal.

The switching elements may be thin-film diodes and bulk transistors having two or three terminals, as well as the thin-film transistors as specified in the present invention.

In another exemplary embodiment of the present invention, a surface of the interlayer insulating film is planarized.

According to this exemplary embodiment, since the interlayer insulating film has a planarized surface, there is substantially no risk that the pixel electrodes and the alignment layer have steps and recessed portions.

In the present invention, since the filler is packed into the contact holes, there is a risk that the filler protrudes from each contact hole just after the formation of the filler. That is, the protrusions are formed instead of the recessed portions, which are formed by related art manufacturing methods. However, in this exemplary embodiment, such protrusions or projecting portions can be eliminated by planarization.

Thus, according to this exemplary embodiment, the following problem can be reduced or prevented: the degradation of image quality caused by light leakage due to the steps.

The planarization specified in this exemplary embodiment includes, for example, a CMP (Chemical Mechanical Polishing) process and an etch-back process. However, other various planarizing processes may be used.

The CMP process is generally defined as a technique in which a substrate for treatment is placed in contact with a polishing pad at each surface and polishing liquid (slurry) containing silica particles is supplied to the contact portion while the substrate and the polishing pad are spun, thereby mechanically and chemically polishing the substrate surface to planarize the surface.

The etch-back process is generally defined as a technique in which a flat film, including photoresist, SOG (Spin-on Glass) or the like, functioning as a sacrificial layer is formed on a substrate having an irregular surface and the sacrificial layer is then etched until the irregular surface appear (that is, the irregular surface is planarized), thereby making the surface flat. However, in the present invention, such a sacrificial layer is not necessarily required. For example, such a flat surface may be obtained according to the following procedure: the contact holes are filled with the filler such that the filler protrudes from the interlayer insulating film, that is, the filler spills over from each contact hole, and the portions protruding from the contact holes are then eliminated by an etching process to allow the filler to remain only in the contact holes, thereby providing the flat surface.

In another exemplary embodiment of the present invention, the filler includes a light-shielding material.

In this exemplary embodiment, the filler including the light-shielding material reduces or securely prevents light leakage caused by vacant contact holes. Since light propagation is interrupted by the filler, there is no risk that light transmitted in the vacant contact holes is mixed with light to display an image. This effect allows an image having higher quality to be displayed.

Furthermore, according to this exemplary embodiment, in the case that thin-film transistors are used for the switching elements, light is prevented from entering semiconductor layers of the thin-film transistors and is particularly prevented from entering the channel regions of the semiconductor layers because light is not transmitted through the filler. Therefore, a so-called light leakage current is reduced or prevented as much as possible from being generated, thereby displaying a high-quality image having no flicker.

The light-shielding material specified in this embodiment includes, for example, single metal, alloy, a metal silicide, or a metal silicide, polysilicide containing at least one selected from the group including Ti (titanium), Cr (chromium), W (tungsten), Ta (tantalum), and Mo (molybdenum). These materials may be used alone or in combination.

In another exemplary embodiment of the present invention, the filler includes a transparent conductive material.

In this exemplary embodiment, the filler may include the same material as that of the pixel electrodes, because the pixel electrodes usually comprise a transparent conductive material, such as ITO (Indium Tin Oxide) or IZO (Indium Zinc Oxide). Thus, according to this exemplary embodiment, the pixel electrodes and the filler to eliminate the cavity of each contact hole can be formed in the same process, thereby reducing the manufacturing cost.

Furthermore, in this exemplary embodiment, the contact holes usually have a length larger than the thickness of the pixel electrodes, which are disposed at part of the top layer. Therefore, even if the filler includes a transparent conductive material, it is expected to obtain a light-shielding effect with a certain level. That is, since the transparency is small as the thickness is large, the transmissivity is small. Thus, the light-shielding effect in this exemplary embodiment may be inferior to that of the above light-shielding material. However, in this exemplary embodiment, it can be expected that light is prevented from being propagated in the contact holes or such light is reduced.

In another exemplary embodiment of the present invention, the contact holes have a coating member disposed on the wall thereof, and the filler is disposed on the coating member.

In this exemplary embodiment, each contact hole has a double layer structure including of the coating member and the filler. That is, the inner layer corresponds to the filler and the outer layer corresponds to the coating member. Therefore, a configuration in which the coating member includes a high conductive material and the filler includes a high light-shielding material can be employed. Thereby, the above various effects can be obtained in tandem. The combination of such effects can be changed depending on needs, for example, the need for higher light-shielding properties and so on among the effects.

In order to address or solve the above, an electro-optical device of the present invention includes a substrate; pixel electrodes disposed above the substrate; switching elements arranged so as to correspond to the pixel electrodes; an interlayer insulating film disposed at a position higher than the switching elements and lower than the pixel electrodes; contact holes, disposed in the insulating film, to connect the switching elements to the corresponding pixel electrodes; conductive coating members each disposed on the wall of each contact hole; and filler disposed on each coating member.

In an exemplary embodiment of the present invention, the filler preferably includes a polyimide material.

According to such a configuration, since an alignment layer including a polyimide material is usually disposed on the pixel electrodes, the alignment layer and the filler can be formed in the same process, in the same way a configuration in which the filler includes a conductive material. That is, the manufacturing process can be simplified, thereby reducing the manufacturing cost.

In this exemplary embodiment, the filler does not include a conductive material. However, the electrical connection of the switching elements to the pixel electrodes can be achieved as long as the coating members include a conductive material. Therefore, it is not necessary that the filler includes a conductive material in this exemplary embodiment. In the above description, the filler includes a polyimide material. However, the filler may include an insulating material, such as oxides or nitrides, instead of the polyimide material depending on needs.

In another exemplary embodiment of the present invention, the electro-optical device includes the pixel electrodes arranged in a matrix, scanning lines and data lines arranged in a matrix and connected to the corresponding switching elements, the switching elements being thin-film transistors; and a light-shielding region arranged so as to correspond to the scanning lines and the data lines, and the contact holes are disposed in the light-shielding region.

According to this exemplary embodiment, since the contact holes are disposed in the light-shielding region, the aperture ratio can be increased. The light-shielding region may include a light-shielding layer in addition to the scanning lines and the data lines, thereby reducing the quantity of light entering the contact holes. Thus, in this exemplary embodiment, a configuration in which almost no light leakage is caused by the contact holes can be obtained, thereby displaying a high-quality image using this effect in combination with the above effects, which is provided by filler according to the present invention.

A method for manufacturing an electro-optical device according to the present invention includes: forming switching elements above a substrate; forming an interlayer insulating film above the switching elements; forming contact holes, extending to the corresponding semiconductor layers, in the interlayer insulating film; forming filler including a conductive material in the contact hole; and forming thin-films, including a transparent conductive material and electrically connected to the filler, above the interlayer insulating film so as to function as pixel electrodes.

According to the method for manufacturing an electro-optical device according to the present invention, the above-mentioned electro-optical device of the present invention can be advantageously manufactured.

The step of forming the filler and the step of forming the thin-films functioning as pixel electrodes specified in the present invention may be combined. In this case, when the pixel electrodes are formed, the filler is also formed (the reverse is also true). Therefore, the pixel electrodes and the filler are formed by forming a single layer comprising a conductive material. Thereby, the manufacturing cost can be reduced.

The term “forming contact holes extending to the corresponding switching elements”, as specified in the present invention, includes the term “forming the contact hole so as to directly extend to corresponding semiconductor layers of the switching elements”.

The above term also represents a configuration in which the semiconductor layers of the switching elements are in contact with other contact holes that are not in contact with the former contact holes directly, and are in contact with an interconnect layer connected to the former contact holes.

That is, the above term “contact holes each extending to corresponding semiconductor layers of the switching elements” represents such a situation that the contact holes are electrically connected to the corresponding semiconductor layers of the switching elements directly or indirectly.

In order to address or solve the above, a method for manufacturing an electro-optical device of the present invention includes: forming switching elements above a substrate; forming an interlayer insulating film above the switching elements; forming contact holes, extending to the corresponding semiconductor layers, in the interlayer insulating film; forming coating members on the wall of contact holes; and forming filler on the coating member.

According to the above manufacturing method, the electro-optical device includes the contact holes having the coating member disposed on the wall thereof.

In an exemplary embodiment of the present invention, the manufacturing method further includes: planarizing a surface of the interlayer insulating film having the contact holes after the step of forming the filler.

According to this exemplary embodiment, for example, protrusions or projecting portions that are parts of the filler or parts of the coating members spilling over from the contact holes can be eliminated by the planarization, thereby obtaining a flat surface.

In this exemplary embodiment, the planarization includes a CMP process, an etch-back process and so on, as described above.

In a method for manufacturing an electro-optical device of the present invention, when the forming of the filler and the forming of the thin-films functioning as the pixel electrodes are combined as described above, the pixel electrodes on the interlayer insulating film and the filler in the contact holes are formed in the same process using the same material and the formed portions are then planarized.

In order to address or solve the above, an electronic apparatus of the present invention includes an electro-optical device of the present invention.

Since the electronic apparatus of the present invention includes such an electro-optical device of the present invention, the following electronic equipment to display a high-quality image without causing the degradation of image quality, such as low contrast due to contact holes, can be provided: a projection-type display unit (liquid crystal projector), a liquid crystal television, a mobile phone, an electronic notebook, a word processor, a video tape recorder having a viewfinder or a monitor, a workstation, a picture phone, a POS terminal, and a touch panel.

Features and the advantages of the present invention will be clarified further by the exemplary embodiments described below.

### BRIEF DESCRIPTION OF THE DRAWINGS

FIG. 1 is a schematic showing an equivalent circuit including various elements, wiring lines and the like, where elements are disposed at a plurality of corresponding pixels, arranged in a matrix, included in an image display region of the electro-optical device according to the first exemplary embodiment of the present invention;

FIG. 2 is a plan view showing a plurality of pixels adjacent each other on a TFT array substrate having data lines, scanning lines, and pixel electrodes in the electro-optical device according to the first exemplary embodiment of the present invention;

FIG. 3 is a sectional view taken along plane A-A′ of FIG. 2;

FIG. 4 is another sectional view, taken along plane A-A′, showing an electro-optical device according to a second exemplary embodiment of the present invention, where this electro-optical device has substantially the same configuration as that of the electro-optical device of the first embodiment shown in FIG. 3 and the electro-optical device of the second exemplary embodiment includes contact holes filled with filler including a material different from the filler included in the electro-optical device of the first exemplary embodiment;

FIG. 5 is another sectional view, taken along plane A-A′, showing the electro-optical device according to the second exemplary embodiment, where this electro-optical device has substantially the same configuration as that of the electro-optical device of the first exemplary embodiment shown in FIG. 3 and this electro-optical device includes contact holes having coating members that are not included in the electro-optical device of the first exemplary embodiment;

FIG. 6 is another sectional view, taken along plane A-A′, showing a variation of an electro-optical device of the present invention, where this variation has contact holes having two layers of coating members;

FIG. 7 is another sectional view, taken along plane A-A′, showing another variation of an electro-optical device of the present invention, where this variation has substantially the same contact holes as those of the variation of FIG. 6 and the contact holes extend to an area having pixel electrodes;

FIG. 8 is a plan view showing a TFT array substrate of an electro-optical device according to an exemplary embodiment of the present invention, the TFT array substrate having various components thereon, when viewed from the side of a counter substrate;

FIG. 9 is a sectional view taken along plane H-H′ of FIG. 8;

FIG. 10 is a flowchart showing a method for manufacturing the electro-optical device of the first exemplary embodiment of the present invention according to the procedure of the method;

FIGS. 11(1)-11(5) are sectional views showing a method for manufacturing the electro-optical device of the first exemplary embodiment of the present invention according to the manufacturing steps, and FIGS. 11(1) to 11(5) correspond to Steps S13 to S17 respectively in FIG. 10;

FIG. 12 is a schematic sectional view showing a color liquid crystal projector, which is an example of a projection-type color display unit according to an exemplary embodiment of the present invention.

### DETAILED DESCRIPTION OF PREFERRED EMBODIMENTS

Exemplary Embodiments of the present invention are described below with reference to the accompanying drawings. The following exemplary embodiments illustrate liquid crystal apparatuses including an electro-optical device of the present invention.

(First Exemplary Embodiment)

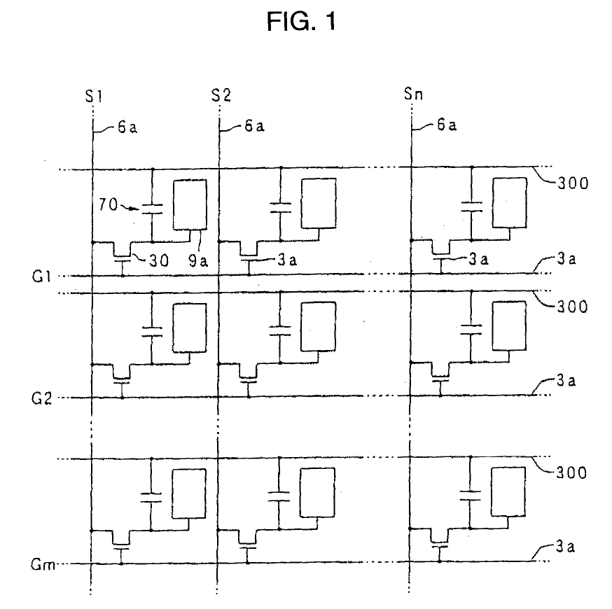

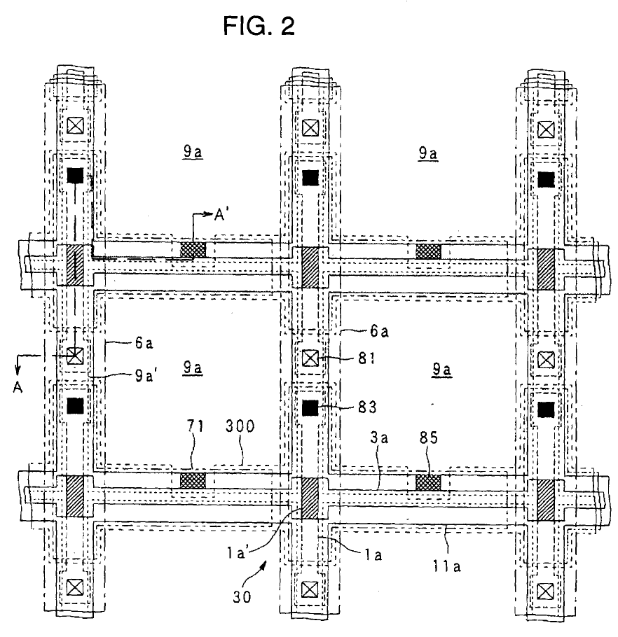

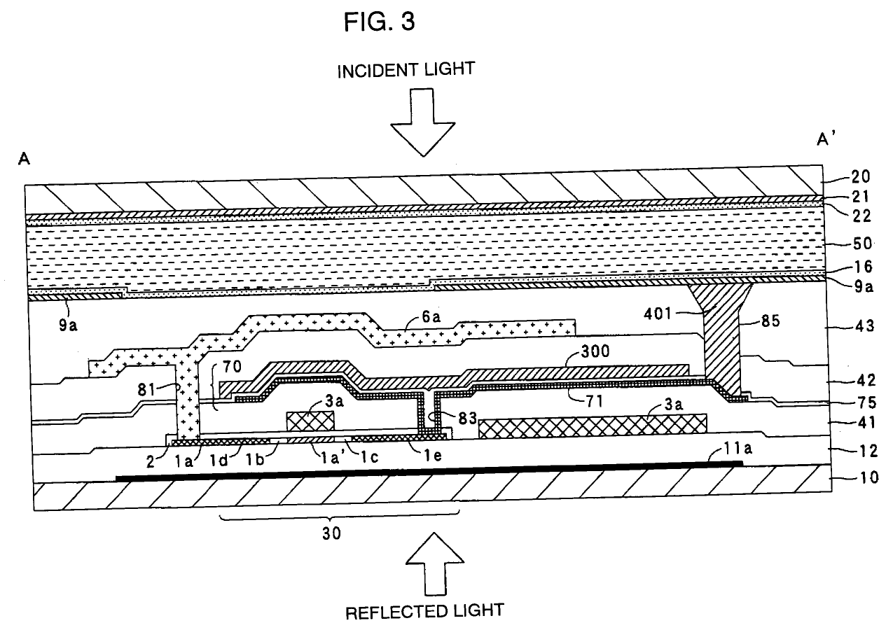

A configuration of a pixel portion of an electro-optical device according to a first exemplary embodiment of the present invention is described with reference to FIGS. 1 to 3. FIG. 1 shows an equivalent circuit including various elements and wiring lines in a plurality of pixels, arranged in a matrix, included in an image-displaying region of the electro-optical device. FIG. 2 is a plan view showing a plurality of pixels adjacent to each other on a TFT array substrate having data lines, scanning lines, and pixel electrodes. FIG. 3 is a sectional view taken along plane A-A′ of FIG. 2. In FIG. 3, different scales are used for layers and components in order to show the layers and components in a recognizable size.

In FIG. 1, the plurality of pixels, arranged in a matrix, included in the image-displaying region of the electro-optical device of the first exemplary embodiment each have a pixel electrode 9a; a TFT 30 to turn on and off the pixel electrode 9a; and a data line 6a, electrically connected to the source electrode of the TFT 30, to receive image signals. The image signals S1, S2, . . . , and Sn written into the data line 6a may be supplied in this order in a linear sequence or may be supplied to the groups including the plurality of data lines 6a adjacent to each other.

The scanning line 3a is electrically connected to the gate electrode of TFT 30, such that scanning signals G1, G2, . . . , and Gm are applied to the scanning line 3a in this order in a linear sequence in a pulse mode with predetermined timing. The pixel electrode 9a is electrically connected to the drain electrode of the TFT 30 so as to turn on the TFT 30 functioning as a switching element for a predetermined period to write the image signals S1, S2, . . . , and Sn, received from the data line 6a, into each liquid crystal with predetermined timing.

The image signals S1, S2, . . . , and Sn, transmitted through the pixel electrode 9a, written into the liquid crystal, which is an example of an electro-optical material, are retained between the pixel electrode 9a and a common electrode disposed on a counter substrate for a predetermined period. In the liquid crystal, the orientation and/or the order of molecular aggregate are changed depending on the intensity of an applied voltage, thereby modulating light and displaying a gray-scale image. In a normally white mode, the transmissivity of incident light is decreased in proportion to the intensity of a voltage applied to each pixel. In a normally black mode, the transmissivity of incident light is increased in proportion to the intensity of a voltage applied to each pixel. Thus, the electro-optical device emits light having contrast depending on the image signals.

Each storage capacitor 70 to reduce or prevent the retained image signals from leaking is disposed in parallel to the liquid crystal capacitor disposed between the pixel electrode 9a and the common electrode. The storage capacitor 70 is disposed along each scanning line 3a and includes a constant potential capacitor electrode connected to the capacitor line 300 having a constant potential.

A practical configuration of the electro-optical device is described below with reference to FIGS. 2 and 3, wherein the electro-optical device has the above circuit including the data lines 6a, the scanning lines 3a, the TFTs 30 and so on.

FIG. 3 is a sectional view taken along plane A-A′ of FIG. 2. As shown in FIG. 3, the electro-optical device according to the first exemplary embodiment includes a transparent TFT array substrate 10 and a transparent counter substrate 20 facing the TFT array substrate 10. The TFT array substrate 10 includes, for example, crystal, glass, or silicon. The counter substrate 20 includes, for example, glass or crystal.

As shown in FIG. 3, the pixel electrodes 9a are disposed above the TFT array substrate 10 and a first alignment layer 16, subjected to orientation treatment, such as rubbing treatment, is disposed on the pixel electrodes 9a. The pixel electrodes 9a include a transparent conductive material, such as ITO (Indium Tin Oxide). On the other hand, a common electrode 21 is disposed over the lower surface of the counter substrate 20 and a second alignment layer 22 subjected to the orientation treatment is disposed under the common electrode 21. In the same way the above pixel electrodes 9a, the common electrode 21 also includes a transparent conductive material, such as ITO. The first and second alignment layers 16 and 22 include a transparent organic material, such as polyimide.

Referring back to FIG. 2, the plurality of pixel electrodes 9a (the outline is indicated by dotted line 9a′) are disposed on the TFT array substrate 10 in a matrix. Each data line 6a extends along each vertical boundary between the pixel electrodes 9a and each scanning line 3a along each horizontal boundary between the pixel electrodes 9a. The data lines 6a include an alloy or metal, such as aluminum. Each scanning line 3a is arranged at an area facing each channel region 1a′, which corresponds to each hatched area in FIG. 2, in a semiconductor layer 1a. The scanning line 3a functions as a gate electrode. That is, each TFT 30 to turn on and off each pixel is disposed at an intersection of the scanning line 3a and the data line 6a. The TFT 30 includes the scanning line 3a, of which a main line portion functions as the gate electrode, disposed at the channel region 1a′.

As shown in FIG. 3, the TFT 30 has an LDD (Lightly Doped Drain) structure and includes the following components, as described above: the scanning line 3a functioning as the gate electrode; the channel region 1a′, disposed in the semiconductor layer 1a including, for example, polysilicon, having a channel formed with an electric field applied from the scanning line 3a; an insulating film 2 including a gate insulating film to insulate the scanning line 3a from the semiconductor layer 1a; a lightly doped source region 1b; a lightly doped drain region 1c; a highly doped source region 1d; and a highly doped drain region 1e. These regions are included in the semiconductor layer 1a.

The TFT 30 preferably has the LDD structure, as shown in FIG. 3, and may have a offset structure in which an impurity is not implanted into the lightly doped source region 1b and the lightly doped drain region 1c. Furthermore, the TFT 30 may be a self-aligning type. The self-aligning type TFT includes a highly doped source region and a highly doped drain region formed in a self-aligning manner by implanting an impurity into a semiconductor layer using the gate electrode, which is part of the scanning line 3a, as a mask. In the first exemplary embodiment, the TFT 30 to turn on and off each pixel has a single gate structure in which a single gate is disposed between the highly doped source region 1d and the highly doped drain region 1e. However, the TFT 30 may include two or more gates disposed therebetween. When the TFT 30 has a dual, triple or more gate structure, current is prevented from leaking at the junctions of the channel and the source and drain regions, such leakage is reduced, thereby reducing the current while the pixel is turned off. The semiconductor layer 1a of the TFT 30 may include a non-single crystal or a single crystal. The single crystal is manufactured by a known, related art or later developed method, such as a bonding method. When the semiconductor layer 1a includes a single crystal, the performance of peripheral circuits can be particularly increased.

As shown in FIG. 3, each storage capacitor 70 has a configuration in which a dielectric film 75 is placed between an interconnect layer 71 functioning as a pixel-potential capacitor electrode and part of the capacitor line 300 functioning as a constant potential capacitor electrode, such that the pixel-potential capacitor electrode is connected to the pixel electrode 9a and the highly doped drain region 1e of the TFT 30. This storage capacitor 70 greatly enhances the potential retention characteristics of the pixel electrode 9a.

The interconnect layer 71 includes, for example, polysilicon and functions as a pixel-potential capacitor electrode. In the same way the capacitor line 300, the interconnect layer 71 may include metal or alloy and may have a single layer structure or a multilayer structure. In addition to the function of the pixel-potential capacitor electrode, the interconnect layer 71 has the function of connecting the pixel electrode 9a to the highly doped drain region 1e of the TFT 30 through second and third contact holes 83 and 85 respectively.

In the case of using the interconnect layer 71, even if the interlayer distance is large, for example, about 2000 nm, connecting both layers with a single contact hole, which is technically difficult, can be avoided. That is, it is possible to satisfactorily connect both layers each other with two or more contact holes, arranged in series, having a relatively small diameter, thereby increasing the aperture ratio. Furthermore, over etching during the formation of contact holes can be prevented.

Each capacitor line 300 includes a conductive material, such as metal or alloy, and functions as a constant potential capacitor electrode. As shown in FIG. 2, the capacitor line 300 is disposed above an area where each scanning line 3a is placed, when viewed from above. In particular, the capacitor line 300 includes main lines extending along the scanning line 3a and protrusions extending upward from the intersections of the data lines 6a and the capacitor line 300 along the data lines 6a and includes slightly constricted portions corresponding to the third contact holes 85. The protrusions contribute to increase a space, between the scanning line 3a and the data line 6a, for forming the storage capacitor 70.

The capacitor lines 300 preferably include a conductive light-shielding material containing high melting metal and function as the constant-potential capacitor electrode of the storage capacitor 70. Each capacitor line 300 is located above the TFT 30 and functions as a light-shielding layer to shield the TFT 30 from incident light.

The capacitor lines 300 preferably extend from the image-displaying region 10a having the pixel electrodes 9a to the periphery thereof and are electrically connected to a constant potential source to have a constant potential. The constant potential source may have a positive or negative constant potential, which is supplied to the data-line driving circuit 101, or the constant potential supplied to the common electrode 21 of the counter substrate 20.

As shown in FIG. 3, the dielectric film 75 includes a silicon nitride film or a silicon oxide film, such as an HTO (High Temperature Oxide) film or an LTO (Low Temperature Oxide) film and has a relatively small thickness, for example, about 5 to 200 nm. In order to increase capacity of the storage capacitor 70, the dielectric film 75 preferably have a small thickness as long as the reliability of the film is maintained.

In the electro-optical device of the first embodiment having the above features, the third contact holes 85 to connect the interconnect layers 71 to the pixel electrodes 9a have a characteristic configuration. As shown in FIG. 3, each third contact hole 85 in the first exemplary embodiment extends through a second interlayer insulating film 42 and a third interlayer insulating film 43 and is filled with a first filler 401. In the first exemplary embodiment, the first filler 401 includes a conductive and light-shielding material, such as a single metal, an alloy, a metal silicide, or a metal polysilicide containing at least one selected from the group including Ti (titanium), Cr (chromium), W (tungsten), Ta (tantalum), and Mo (molybdenum).

The second interlayer insulating film 42 is located on the storage capacitor 70 disposed on a first interlayer insulating film 41, which is described below, and includes each first contact hole 81 to electrically connect each data line 6a to the highly doped source region 1d of each TFT 30 in addition to the third contact holes 85. The third interlayer insulating film 43 is located on the data line 6a disposed on the second interlayer insulating film 42. The second and third interlayer insulating films 42 and 43 include, for example, silicate glass, silicon nitride, or silicon oxide. Both films have a thickness of, for example, about 500 to 1500 nm.

As described in a below-mentioned manufacturing method in detail, a surface of the third interlayer insulating film 43 having the third contact holes 85 filled with the first filler 401 is planarized. As shown in FIG. 3, the entire top surface of the third interlayer insulating film 43 including the third contact holes 85 is flat.

As shown in FIGS. 2 and 3, the TFT 30 has a lower light-shielding film 11a thereunder in addition to the above components. The lower light-shielding film 11a has a grid pattern, thereby partitioning the pixels. The data lines 6a extending in the vertical direction in FIG. 2 and the capacitor lines 300 extending in the horizontal direction cross each other and also partition the pixels. In the same way the capacitor lines 300, the lower light-shielding film 11a preferably extends from the image-displaying region to the periphery and is connected to a constant potential source in order to avoid adverse effects caused by a potential change, on the TFT 30.

The TFT 30 has an insulating base film 12 thereunder. The insulating base film 12 insulates the TFT 30 from the lower light-shielding film 11a. Since the insulating base film 12 is disposed over the TFT array substrate 10, the insulating base film 12 prevents changes in the characteristics of the TFT 30 to turn on and off each pixel, or reduces such changes, where the changes are caused by roughness arising during the polishing of a surface of the TFT array substrate 10 and are caused by contaminants remaining after washing treatment.

The first interlayer insulating film 41 is disposed on each scanning line 3a and has each first contact hole 81 extending to the highly doped source region 1d and each second contact hole 83 extending to the highly doped drain region 1e.

In this exemplary embodiment, the first interlayer insulating film 41 may be baked at about 1000° C. or more to activate ions implanted in a polysilicon layer included in the semiconductor layer 1a and the scanning line 3a. In contrast, the second interlayer insulating film 42 may not be baked and the stress, arising at the interface between the capacitor line 300 and the second interlayer insulating film 42, is reduced.

In the electro-optical device having the above configuration, the second contact holes 85 containing the first filler 401 provide the following effects.

Related art contact holes have a cavity therein. In contrast, since the second contact holes 85 are filled with the first filler 401, a component disposed on each second contact hole 85 has no recessed portion, corresponding to the above cavity, thereunder. Thus, as shown in FIG. 3, the pixel electrode 9a and the first alignment layer 16 do not have such a recessed portion. Therefore, the disorder of orientation does not arise in liquid crystal molecules in a liquid crystal layer in contact with the recessed portion, thereby preventing the occurrence of problems, such as inferior image quality caused by, for example, low contrast, or reduces the occurrence of such problems. Accordingly, the electro-optical device of the first exemplary embodiment can display a high-quality image.

In the first exemplary embodiment, such effects become more significant when the third interlayer insulating film 43 including the third contact holes 85 has a planarized surface. Just after the formation of the first filler 401, the first filler 401 protrudes from the surface of the third interlayer insulating film 43. In contrast, recessed portions formed by a related art method. According to the first exemplary embodiment, such projecting portions or protrusions can be removed to provide a flat surface. This procedure is described in a below-mentioned manufacturing method.

Since the first filler 401 includes a conductive material, each pixel electrode 9a is electrically connected to each interconnect layer 71 and is further electrically connected to the highly doped drain region 1e of each TFT 30 effectively. Since each third contact hole 85 is filled with the conductive first filler 401, the contact portion between the third contact hole 85 and the interconnect layer 71 and the contact portion between the third contact hole 85 and the pixel electrode 9a have a large area, thereby lowering the resistance of each contact portion. Thus, image signals can be more securely supplied to the pixel electrode 9a as compared with related art methods.

Furthermore, since the first filler 401 also includes a light-shielding material and there are no or substantially no cavities, as described above, the light-shielding properties are enhanced. Therefore, in the first exemplary embodiment, the third contact hole 85 reduces or prevents light from entering the TFT 30 and particularly reduces or prevents light from entering the channel region 1a′in the semiconductor layer 1a of the TFT 30, thereby reducing or preventing a light leakage current from being generated. Thus, according to the first exemplary embodiment, a high-quality image can be displayed without a flicker.

(Second Exemplary Embodiment)

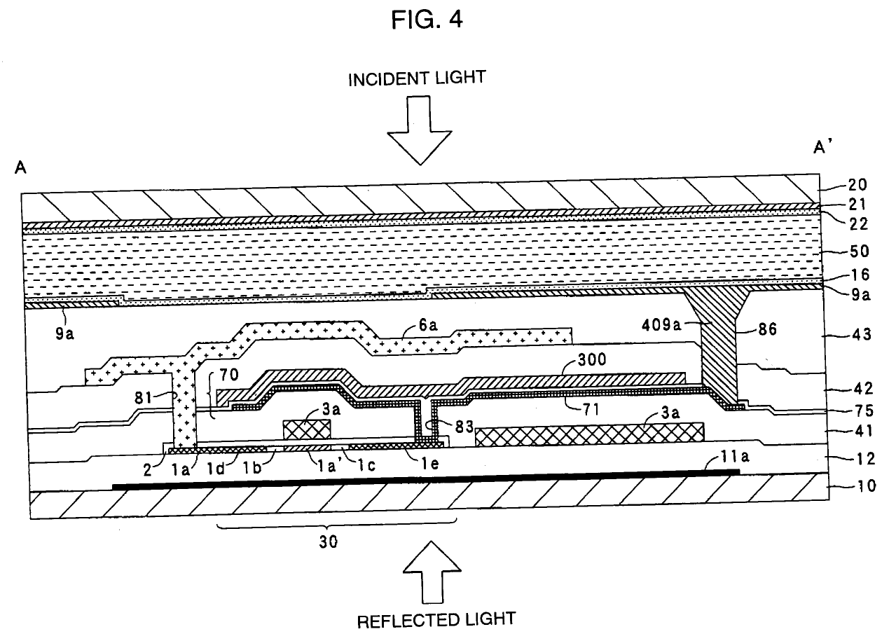

A second exemplary embodiment of the present invention is described below with reference to FIG. 4. FIG. 4 shows substantially the same configuration as that shown in FIG. 3. The configuration shown in FIG. 4 has fourth contact hole 86 instead of the third contact hole 85 shown in FIG. 3. In FIG. 4, portions having the same reference numerals as those of the portions in FIG. 3 are the same components as those in the first exemplary embodiment and the description is omitted.

In the second exemplary embodiment, the fourth contact hole 86 contains a second filler 409a including ITO used for pixel electrode 9a Thus, according to the second exemplary embodiment, the pixel electrode 9a and the second filler 409a in the fourth contact hole 86 can be formed in the same process, thereby reducing the manufacturing cost.

In the second exemplary embodiment, as shown in FIG. 4, the fourth contact hole 86 has a length larger than the thickness of the pixel electrode 9a. Therefore, it can be expected that the second filler 409a including ITO, which is a transparent material, have a considerable light-shielding effect. The light-shielding effect may be inferior to that in the first exemplary embodiment. However, in the second exemplary embodiment, it can be expected that light is prevented from being propagated in the fourth contact hole 86 or such light is reduced.

In the second exemplary embodiment, the following effects described can be also obtained in substantially the same manner as that in the first exemplary embodiment: the light-shielding effect due to no cavity under the pixel electrode 9a and the first alignment layer 16 and the effect of reducing the resistance by increasing the area of the contact portion of the second filler 409a and the interconnect layer 71.

(Third Exemplary Embodiment)

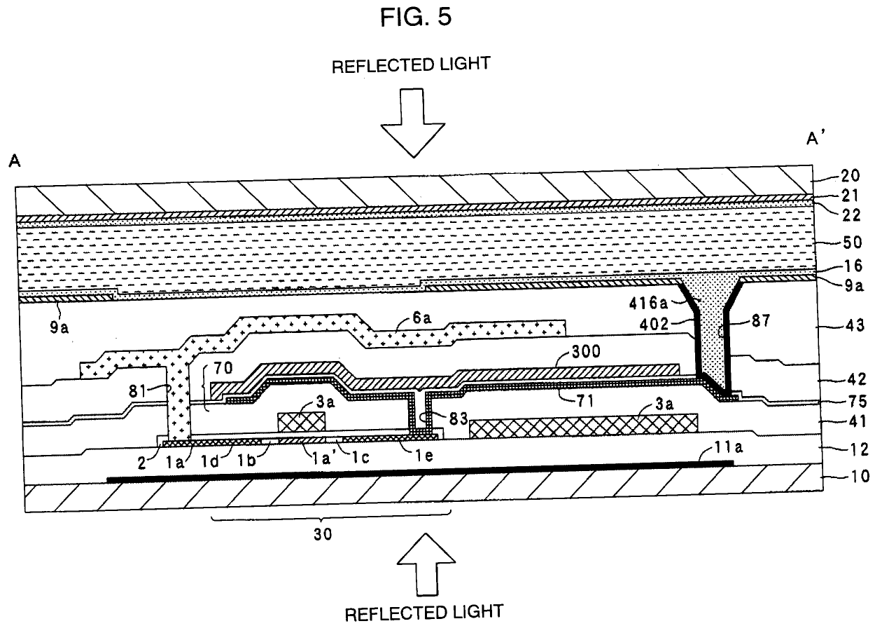

A third exemplary embodiment of the present invention is described below with reference to FIG. 5. FIG. 5 shows substantially the same contents as those of FIG. 3. In FIG. 5, portions having the same reference numerals as those of the portions in FIG. 3 are the same components as those of the first exemplary embodiment and the description is omitted.

In the third exemplary embodiment, each fifth contact hole 87 contains a third filler 416a including a transparent polyimide material used for a first alignment layer 16. Furthermore, a first coating member 402 is disposed on the wall of the fifth contact hole 87, using the same material as the first filler 401 in the first exemplary embodiment. Thus, the first coating member 402 has light-shielding properties and conductivity.

In such a configuration, it is clear that the third embodiment provides substantially the same effects as those of the first exemplary embodiment.

Furthermore, in the third exemplary embodiment, the following effects can be obtained in addition to the above effects. That is, the light-shielding properties and conductivity can be achieved with the first coating member 402. In addition, the third filler 416a and the first alignment layer 16 can be formed in the same process, thereby reducing the manufacturing cost.

In the present invention, there are basically no problems if the first coating member 402 and the third filler 416a include any material in general. However, since the fifth contact hole 87 must connect the pixel electrode 9a to the interconnect layer 71, the first coating member 402 needs to include a conductive material in principle.

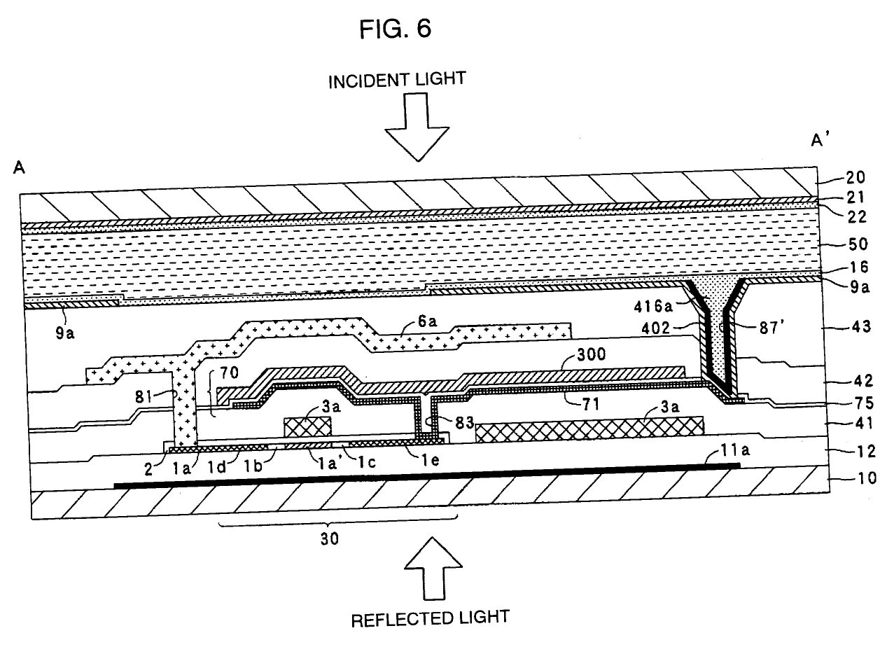

The first coating member 402 may include one or more layers. For example, as shown in FIG. 6, a first layer corresponds to an ITO coating member extending from the pixel electrode 9a and a second layer corresponds to another coating member that is substantially the same as the first coating member 402 shown in FIG. 5. A configuration having a sixth contact hole 87′ filled with the third filler 416a is also within the scope of the present invention.

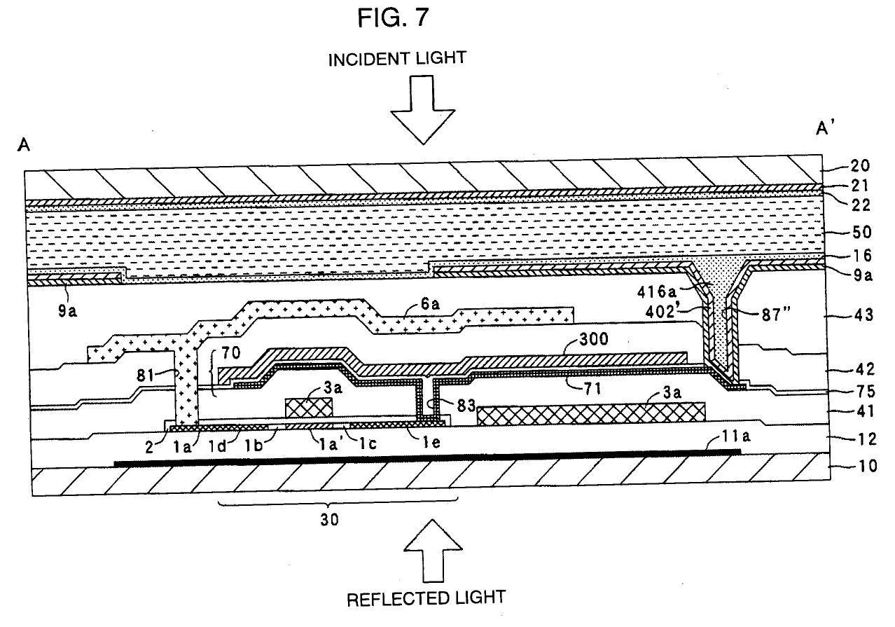

FIG. 7 shows a variation of the configuration shown in FIG. 6. As shown in FIG. 7, the second coating member 402′ extends to the entire area of pixel electrode 9a on a third interlayer insulating film 43. In this configuration, the second coating member 402′ preferably includes a transparent material. However, the second coating member 402′ and the pixel electrode 9a do not need to include a transparent material when an electro-optical device according to this exemplary embodiment is a reflection type, that is, when the electro-optical device displays an image using light that enters a liquid crystal layer 50 in the direction indicated by the term “INCIDENT LIGHT” in FIG. 7 and is then reflected by the pixel electrode 9a to travel in the direction opposite the above direction.

(Entire Configuration of Electro-optical Device)

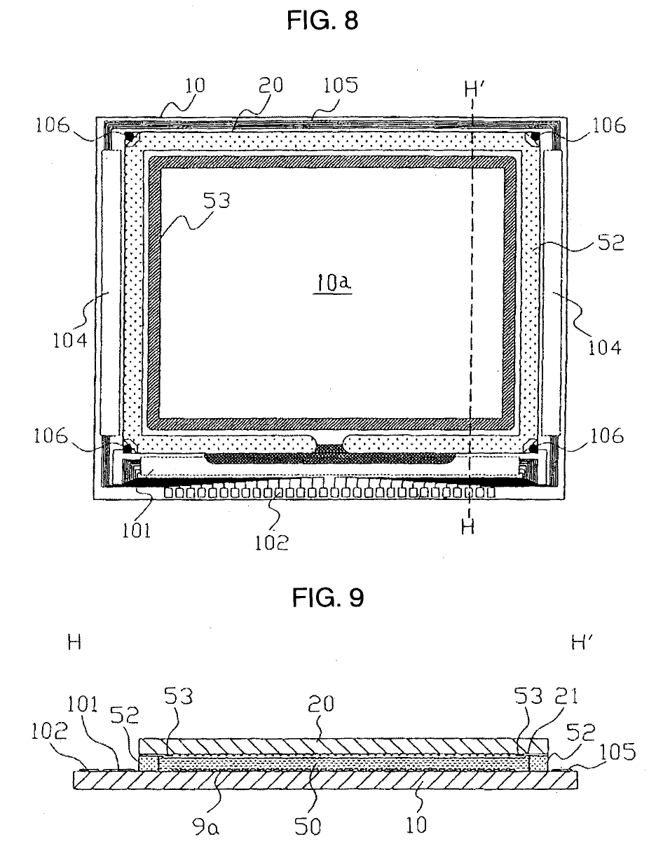

An entire configuration of an electro-optical device according to each exemplary embodiment having the above features is described below with reference to FIGS. 8 and 9. FIG. 8 is a plan view showing a TFT array substrate 10 having various components when viewed from the position of a counter substrate 20. FIG. 9 is a sectional view taken along plane H-H′ of FIG. 8.

As shown in FIGS. 8 and 9, in the electro-optical device according to this exemplary embodiment, the TFT array substrate 10 and the counter substrate 20 are arranged so as to face each other. A liquid crystal layer 50 is sealed between the TFT array substrate 10 and the counter substrate 20, which are joined together with a sealing member 52 disposed in a sealing region located around an image-displaying region 10a.

The sealing member 52 to join both substrates includes, for example, a UV-curing resin, a thermosetting resin or the like and is cured by applying UV rays, heating or the like. The sealing member 52 contains dispersed gap members (spacers), such as glass fibers or glass beads, in order to maintain the distance between both substrates in a predetermined value when a liquid crystal device in this exemplary embodiment is used for a small-sized projector to display an image in an enlarged manner. Alternatively, the liquid crystal layer 50 may contain such gap members when the liquid crystal device is used for a large-sized liquid crystal display or television to display an image at the same scale.

In an area outside the sealing member 52, a data line-driving circuit 101 and external circuit-connecting terminals 102 are disposed along a side of the TFT array substrate 10, such that the data line-driving circuit 101 transmits image signals to data lines 6a with predetermined timing to drive the data lines 6a. Scanning line-driving circuits 104 are disposed along corresponding two sides adjacent to the above side, such that the scanning line-driving circuits 104 transmit scanning signals to scanning lines 3a with predetermined timing to drive the scanning lines 3a. If the delay of the scanning signals transmitted to the scanning lines 3a does not cause problems, the scanning line-driving circuits 104 may be arranged on one side. The data line-driving circuit 101 may be arranged along both sides of the image-displaying region 10a.

A plurality of wiring lines 105 to connect the scanning line-driving circuits 104, disposed on both sides of the image-displaying region 10a, each other are disposed on the remainder of the four sides of the TFT array substrate 10.

A conductive member 106 to electrically connect the TFT array substrate 10 to the counter substrate 20 is disposed at at least one comer of the counter substrate 20.

As shown in FIG. 9, TFTs to turn on and off pixels and pixel electrodes 9a having wiring lines, such as scanning lines and data lines, are disposed on the TFT array substrate 10, and an alignment layer is disposed on the pixel electrodes 9a. A common electrode 21 is disposed under the counter substrate 20 and another alignment layer is disposed under the common electrode 21. The liquid crystal layer 50 is disposed between the two alignment layers and contains, for example, one or more kinds of nematic[?] liquid crystals having predetermined orientation.

(Method for Manufacturing Electro-optical Device)

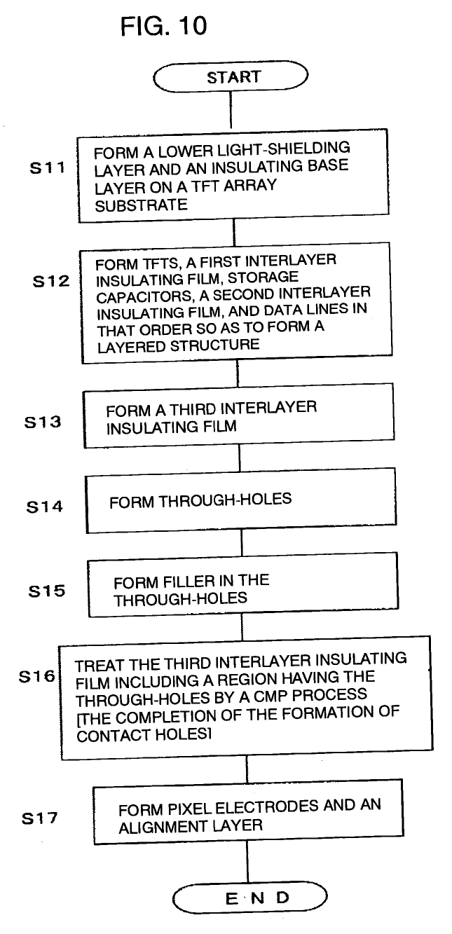

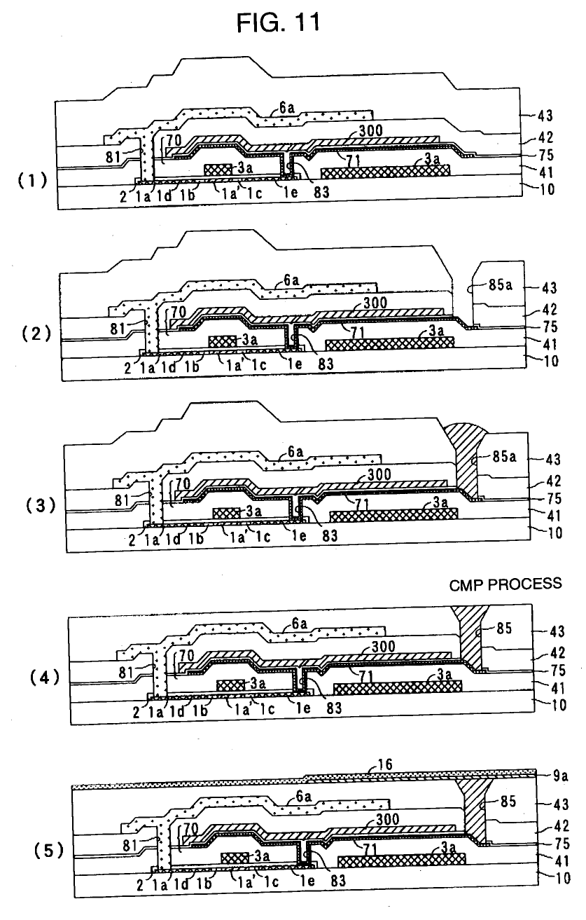

A method for manufacturing the above-mentioned electro-optical device of the first exemplary embodiment is described below with reference to FIGS. 10 and 11(1)-11(5). FIG. 10 is a flowchart showing a method for manufacturing the electro-optical device of the first exemplary embodiment. FIGS. 11(1)-11(5) are sectional views illustrating principal portions of the contact hole-forming step among the steps of manufacturing the electro-optical device.

The first exemplary embodiment features third contact hole 85 to electrically connect the corresponding pixel electrode 9a to the highly doped drain region 1e in the semiconductor layer 1a of the corresponding TFT 30. In the following description of the manufacturing method, the feature is mainly illustrated and the remainders are omitted, as required.

Referring to FIG. 10, in Step S11, a TFT array substrate 10 including, for example, crystal, hard glass, or silicon is prepared, and a lower light-shielding film 11a, a insulating base film 12, and the like are formed on the TFT array substrate 10. The lower light-shielding film 11a is formed according to the following procedure: a film including metal, metal silicide, or alloy containing Ti, Cr, W, Ta, or Mo is formed on the TFT array substrate 10 by a sputtering method so as to have a thickness of about 100 to 500 nm, preferably about 200 nm, and the resulting film is then processed by a photolithographic method and an etching method so as to have a grid pattern. The insulating base film 12 is formed according to the same procedure as that for a third interlayer insulating film 43 described below and preferably has a thickness of about 500 to 2000 nm. Some sub-steps in Step S11 may be omitted depending on needs.

In Step S12 shown in FIG. 10, TFTs 30 each including semiconductor layer 1a, a first interlayer insulating film 41, storage capacitors 70, a second interlayer insulating film 42, and data lines 6a are formed on the insulating base film 12 in that order so as to form a layered structure. In order to form the TFTs 30, the following sub-steps are required: the sub-step of implanting impurity ions into the semiconductor layers 1a, the sub-step of forming a gate-insulating layer 2, and the sub-step forming gate electrodes functioning as parts of scanning lines 3a. In the above sub-steps, known, related art or later developed techniques can be used, and the detailed description is herein omitted. First and second interlayer insulating films 41 and 42 are formed according to the same procedure as that for the third interlayer insulating film 43 described below. The first interlayer insulating film 41 preferably has a thickness of about 500 to 2000 nm, and the second interlayer insulating film 42 preferably has a thickness of about 500 to 1500 nm. In order to form the storage capacitors 70, the following sub-steps are required: the sub-step of forming interconnect layers 71 each including a pixel potential capacitor electrode, the sub-step of forming capacitor lines 300 each including a constant potential capacitor electrode, and the sub-step of forming dielectric films 75. In the first and second sub-steps, a photolithographic method and an etching method in which a conductive material such as Al is used can be employed. In the third sub-step, a photolithographic method and an etching method in which an insulating material such as TaOx is used can be employed.

In Step S13 shown in FIG. 10, the third interlayer insulating film 43 is formed on the data lines 6a. The third interlayer insulating film 43 is formed by an atmospheric or vacuum CVD method using a gas, such as a TEOS (tetraethyl orthosilicate) gas, a TEB (tetraethyl borate) gas, or a TMOP (tetramethyl oxy-phosphate) gas and comprises silicate glass such as NSG (non-silicate glass), PSG (phosphorus silicate glass), BSG (boron silicate glass), or BPSG (boron-phosphorus silicate glass); silicon nitride; or silicon oxide. The third interlayer insulating film 43 has a thickness of, for example, about 500 to 1500 nm. FIGS. 11(1)-11(5) corresponds to a portion shown in FIG. 3 and shows a configuration having the third interlayer insulating film 43. In the following description, sectional views showing manufacturing steps in FIGS. 11(1)-11(5) are referred to according to FIG. 10.

In Step S14 in FIG. 10, as shown in FIG. 11(2), the through-hole 85a is formed in the third interlayer insulating film 43 by a dry etching method such as a reactive ion or reactive ion beam etching method. The through-hole 85a extends through the second interlayer insulating film 42 to the interconnect layer 71.

In Step S15 in FIG. 10, as shown in FIG. 11(3), a light-shielding and conductive material is packed into the through-hole 85a, where the material includes single metal, alloy, metal silicide, metal polysilicide containing at least one selected from the group including Ti (titanium), Cr (chromium), W (tungsten), Ta (tantalum), and Mo (molybdenum). That is, the through-hole 85a is filled with a first filler 401. The first filler 401 is deposited in the through-hole 85a by, for example, a sputtering method such that the first filler 401 protrudes from the surface of the third interlayer insulating film 43.

In Step S16 in FIG. 10, as shown in FIG. 11(4), the surface of the third interlayer insulating film 43 is treated by a CMP process, where the surface has the protrusions comprising the first filler 401. The CMP process is generally defined as a technique in which a substrate for treatment is placed in contact with a polishing pad at each surface and polishing liquid (slurry) containing silica particles is supplied to the contact portion while the substrate and the polishing pad are spun, thereby mechanically and chemically polishing the substrate surface to planarize the surface. Thus, in this exemplary embodiment, the TFT array substrate 10 having the through-hole 85a filled with the first filler 401 corresponds to the above substrate for treatment. As a result of the treatment, as shown in FIG. 11(4), the third interlayer insulating film 43 has a flat surface. The termination of the polishing treatment is determined based on the period of polishing time or based on the state of an appropriate stopper layer disposed at a predetermined area on the TFT array substrate 10. At the point of the termination of the polishing treatment, the third contact holes 85 are completed.

In Step S17 in FIG. 10, as shown in FIG. 11(5), the pixel electrode 9a and a first alignment layer 16 is formed on the flat surface of the third interlayer insulating film 43. In particular, the pixel electrode 9a is formed on the third interlayer insulating film 43 and the first alignment layer 16 including a transparent polyimide material is formed on the pixel electrode 9a by a photolithographic method and an etching method using a transparent conductive material.

As described above, in the electro-optical device of the first exemplary embodiment, each pixel electrode 9a and the first alignment layer 16 do not have a recessed portion thereunder. The reason is as follows: each third contact hole 85 is filled with the first filler 401 to eliminate cavities, which remain in related art configurations; and projecting portions or protrusions are removed by a CMP process after the first filler 401 is formed. Thus, the electro-optical device according to the first exemplary embodiment can display a high-quality image.

In the above description, the first filler 401 is formed so as to protrude from the through-hole 85a. However, the present invention is not limited to such a configuration. For example, the first filler 401 may be formed so as to extend exactly to the surface of the third interlayer insulating film 43. In such a case, it is difficult to obtain a perfectly flat surface, and contact holes with a large cavity remaining can be avoided or reduced. In related art manufacturing methods, such a configuration is provided. However, in the present invention, even if recessed portions are disposed under the pixel electrodes 9a and the first alignment layer 16, the size of the recessed portions can be significantly reduced as compared with the related art manufacturing methods.

In this case, it is not necessary to perform the CMP treatment, thereby saving the manpower and reducing the manufacturing cost. However, even if the first filler 401 is formed so as not to protrude from the corresponding third contact hole 85, it is not entirely useless to perform the CMP treatment, because the third interlayer insulating film 43 generally has various steps thereon, as shown in FIGS. 11(1) to 11(3). The steps are caused by various components disposed below the third interlayer insulating film 43. Accordingly, it is useful to perform the CMP treatment in order to remove such steps.

In the above description, a method for manufacturing an electro-optical device according to the first exemplary embodiment is illustrated. Electro-optical devices according to the second and third exemplary embodiments can be manufactured by substantially the same method as that of the first exemplary embodiment.

For example, in the second exemplary embodiment, the step of forming the pixel electrodes 9a and the second filler 409a in the same process may be employed instead of the step of forming the first filler 401 in the first exemplary embodiment, as shown in Step S15 in FIG. 10. In the third exemplary embodiment, each coating member 402 may be formed on the wall of each fifth contact hole 87 before the first filler 401 are formed, and the third filler 416a and the first alignment layer 16 are then formed in the same process.

(Electronic Apparatus)

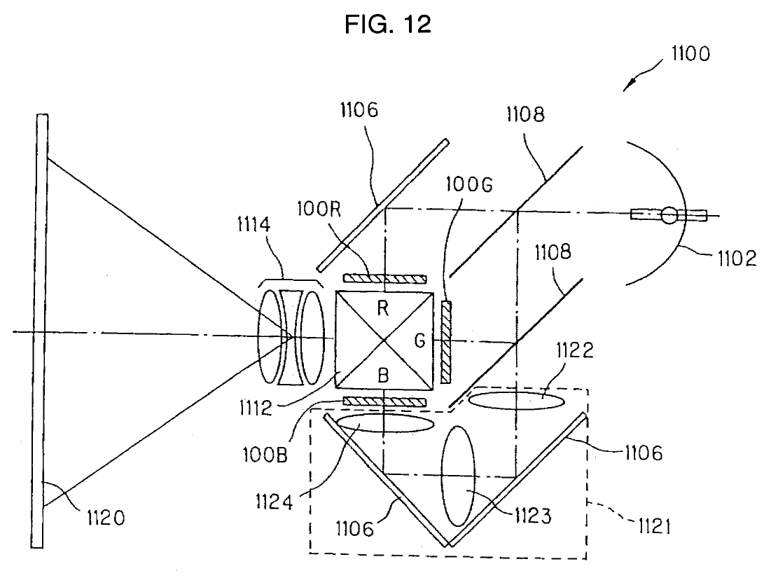

Another exemplary embodiment of the present invention provides a projection-type color display unit, which is an exemplary electronic apparatus including a light valve functioning as an electro-optical device described above in detail. The entire configuration of the display unit is described below. In particular, the optical configuration of the display unit is described. FIG. 12 is a schematic sectional view showing the projection-type color display unit.

FIG. 12 shows a liquid crystal projector 1100, which is an example of the projection-type color display unit of this exemplary embodiment. The liquid crystal projector 1100 is equipped with three liquid crystal modules, which include liquid crystal devices having a TFT array substrate having driving circuits thereon. The liquid crystal modules correspond to a first light valve 100R, a second light valve 100G, and a third light valve 100B to display red, green, and blue, respectively. In the liquid crystal projector 1100, a lamp unit 1102 functioning as a white light source, such as a metal halide lamp, emits light. The emitted light is fractionated by three mirrors 1106 and two dichroic mirrors 1108 into red, green, and blue fractions corresponding to the three primary colors. The red, green, and blue fractions are led to the first light valve 100R, the second light valve 100G, and the third light valve 100B, respectively. Particularly, in this process, the blue fraction is led through a relay lens system 1121 including an entrance lens 1122, a relay lens 1123, and an exit lens 1124 in order to reduce the optical loss due to the long optical path. The red, green, and blue fractions corresponding to the three primary colors are modulated by the first, second, and third light valves 100R, 100G, and 100B, respectively, and are then recombined by a dichroic prism 1112. The recombined fractions are projected on a screen 1120 through a projector lens 1114 to form a color image.

It should be understood that the present invention is not limited to the exemplary embodiments described above. To the contrary, the present invention is intended to cover various modifications within the spirit and scope of the invention as specified in Specification and Claims. An electro-optical device in which such variations are made, a manufacturing method thereof, and an electronic apparatus including such an electro-optical device are within the scope of the present invention.

What is claimed is:

1. An electro-optical device, comprising:
a substrate;
pixel electrodes disposed above the substrate;
switching elements arranged so as to correspond to the pixel electrodes;
an interlayer insulating film disposed at a position higher than the switching elements and lower than the pixel electrodes;
contact holes, disposed in the insulating film, to connect the switching elements to the corresponding pixel electrodes; and
filler, disposed in the corresponding contact holes, including a conductive material.

2. The electro-optical device according to claim 1,
a surface of the interlayer insulating film being planarized.

3. The electro-optical device according to claim 1,
the filler including a light-shielding material.

4. The electro-optical device according to claim 1,
the filler including a transparent conductive material.

5. The electro-optical device according to claim 1,
the contact holes having a coating member disposed on the wall thereof, and
the filler being disposed on coating member.

6. The electro-optical device according to claim 5, the pixel electrodes being arranged in a matrix, the electro-optical device further including:
scanning lines and data lines that are arranged in a matrix and connected to the corresponding switching elements, the switching elements being thin-film transistors; and
a light-shielding region arranged so as to correspond to the scanning lines and the data lines, the contact holes being disposed in the light-shielding region.

7. An electro-optical device, comprising:
a substrate;
pixel electrodes disposed above the substrate;
switching elements arranged so as to correspond to the pixel electrodes;
an interlayer insulating film disposed at a position higher than the switching elements and lower than the pixel electrodes;
contact holes, disposed in the insulating film, to connect the switching elements to the corresponding pixel electrodes, each of the contact holes defining a wall;
conductive coating members disposed on the wall of each contact hole; and
filler disposed on the conductive coating members.

8. The electro-optical device according to claim 7,
the filler including a polyimide material.

9. The electro-optical device according to claim 7, the pixel electrodes being arranged in a matrix, the electro-optical device further comprising:
scanning lines and data lines that are arranged in a matrix and connected to the corresponding switching elements, the switching elements being thin-film transistors; and
a light-shielding region arranged so as to correspond to the scanning lines and the data lines, the contact holes being disposed in the light-shielding region.

10. A method for manufacturing an electro-optical device, comprising:
forming switching elements having semiconductor layers above a substrate;
forming an interlayer insulating film above the switching elements;
forming contact holes, extending to the corresponding semiconductor layers, in the interlayer insulating film;
forming filler including a conductive material in the corresponding contact holes; and
forming thin-films, including a transparent conductive material and electrically connected to the filler, above the interlayer insulating film so as to function as pixel electrodes.

11. The method for manufacturing an electro-optical device according to claim 10, further comprising: planarizing a surface of the interlayer insulating film having the contact holes after forming the filler.

12. A method for manufacturing an electro-optical device, comprising:
forming switching elements having semiconductor layers above a substrate;
forming an interlayer insulating film above the switching elements;
forming contact holes, extending to the corresponding semiconductor layers, in the interlayer insulating film, each of the contact holes defining a wall;
forming a coating member on the wall of the corresponding contact holes; and
forming filler on the coating member.

13. The method for manufacturing an electro-optical device according to claim 12, further comprising: planarizing a surface of the interlayer insulating film having the contact holes after forming the filler.

14. An electronic apparatus, comprising:
an electro-optical device, including:
a substrate;
pixel electrodes disposed above the substrate;
switching elements arranged so as to correspond to the pixel electrodes;
an interlayer insulating film disposed at a position higher than the switching elements and lower than the pixel electrodes;
contact holes, disposed in the insulating film, to connect the switching elements to the corresponding pixel electrodes; and
filler, disposed in the corresponding contact holes, including a conductive material.

15. An electronic apparatus, comprising:
an electro-optical device including:
a substrate;
pixel electrodes disposed above the substrate;
switching elements arranged so as to correspond to the pixel electrodes;
an interlayer insulating film disposed at a position higher than the switching elements and lower than the pixel electrodes;
contact holes, disposed in the insulating film, to connect the switching elements to the corresponding pixel electrodes, each of the contact holes defining a wall;
conductive coating members disposed on the wall of each of the contact holes; and
filler each disposed on the corresponding conductive coating members.
